(19) United States
(12) Patent Application Publication
(10) Pub. No.: US 2011/0307191 A1
(43) Pub. Date: Dec. 15, 2011

(54) METHOD OF DETERMINING POSITION OF A VALVE

(75) Inventors: Louis Lafleur, Cypress, TX (US); Javid Majid, Houston, TX (US); Tyler C. Roberts, Skiatook, OK (US); James Joseph Freeman, Houston, TX (US)

(73) Assignee: BAKER HUGHES INCORPORATED, Houston, TX (US)

(21) Appl. No.: 12/813,270

(22) Filed: Jun. 10, 2010

(51) Int. Cl. G01F 1/36; G01M 3/04

(52) U.S. Cl. 702/47; 702/51

(57) ABSTRACT

A method of determining the position of a valve includes, measuring pressure at a first location within a bore and measuring pressure at a second location within the bore wherein the first location and the second location are positioned on opposing longitudinal sides of the valve. The method further includes analyzing values from the measuring and attributing characteristics of the analyzing to specific valve positions.

### BACKGROUND

Tubular valves, such as flapper valves used in the downhole completion industry, for example, are often configured to automatically actuate in response to changes in environmental conditions surrounding the valve. Although such actuations are effective at quickly preventing unwanted flow under specific conditions, it is sometimes difficult to ascertain an actual position a valve is in at any particular time. Although mechanical monitoring devices exist that serve this function adequately, the industry is always receptive to new devices and methods of determining position of valves.

### BRIEF DESCRIPTION

Disclosed herein is a method of determining the position of a valve. The method includes measuring pressure at a first location within a bore and measuring pressure at a second location within the bore wherein the first location and the second location are positioned on opposing longitudinal sides of the valve. The method further includes analyzing values from the measuring and attributing characteristics of the analyzing to specific valve positions.

Further disclosed herein is a method of determining positions of a valve. The method includes, measuring differences in pressure between locations on opposing longitudinal sides of a valve in operable communication with a bore, and attributing values of differential pressure measured to positions of the valve.

### BRIEF DESCRIPTION OF THE DRAWINGS

The following descriptions should not be considered limiting in any way. With reference to the accompanying drawings, like elements are numbered alike:

FIG. 1 depicts a quarter cross sectional view of a pressure monitoring arrangement configured to enable determination of a position of a valve within a bore as disclosed herein; and

FIG. 2 depicts a quarter cross sectional view of an alternate embodiment of a pressure monitoring arrangement configured to determine a position of a valve within a bore as disclosed herein; and

FIG. 3 depicts a quarter cross sectional view of an alternate embodiment of a pressure monitoring arrangement also configured to determine a position of a valve within a bore as disclosed herein.

### DETAILED DESCRIPTION

A detailed description of one or more embodiments of the disclosed apparatus and method are presented herein by way of exemplification and not limitation with reference to the Figures.

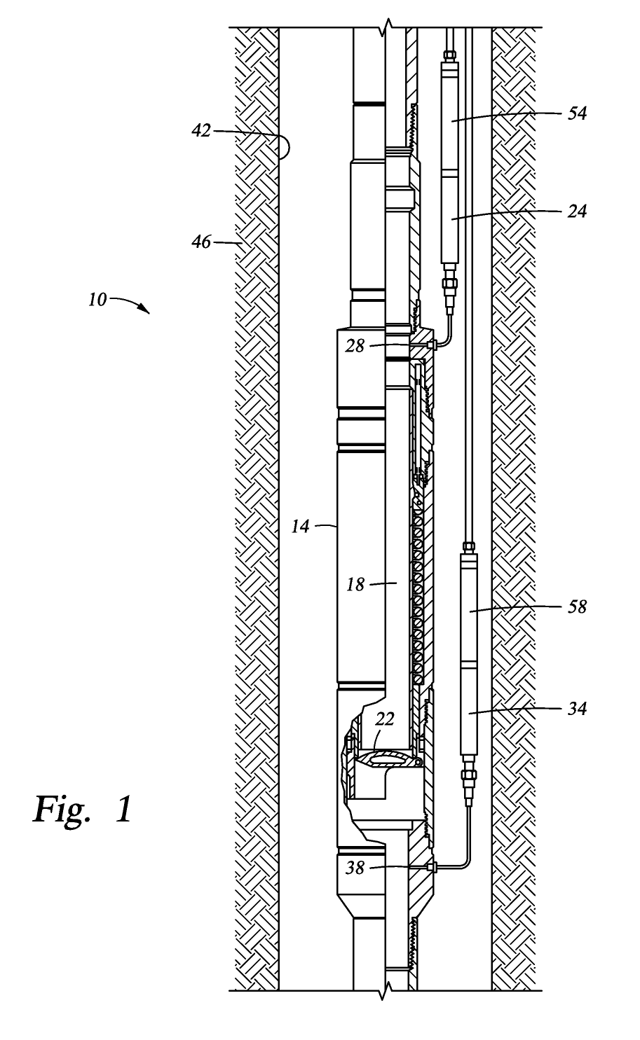

Referring to FIG. 1, a pressure monitoring arrangement employed in methods disclosed herein is illustrated generally at 10. The arrangement 10 includes, a tubular 14 with a bore 18 therethrough having a valve 22, illustrated in this embodiment as a flapper, configured to be moveable between an open position and a closed position (shown in the Figures in the closed position). When in the open position the valve 22 substantially provides no restriction to flow through the bore 18. In contrast, when the valve 22 is in the closed position, flow through the bore 18 is essentially fully blocked. A first pressure transducer 24 is in fluidic communication with a first location 28 defined as being beyond the valve 22 in a first longitudinal direction, while a second pressure transducer 34 is in fluidic communication with a second location 38 defined as being beyond the valve 22 in a second longitudinal direction. In this embodiment the valve 22 is positioned within a borehole 42 in an earth formation 46 and the first location 28 is uphole of the valve 22 while the second location 38 is downhole of the valve 22. It should be noted that the notations of uphole and downhole are arbitrary and do not limit the currently disclosed methods to these orientations.

The foregoing pressure monitoring arrangement 10 allows an operator thereof to determine positions of the valve 22 by the following methods. When the valve 22 is open, the pressure drop across the valve 22 is substantially negligible and thus the pressure reading at the first location 28 is substantially equal to the pressure at the second location 38. An operator, could therefore, attribute similar pressure values at the locations 28, 38, as measured by the respective pressure transducers 24, 34, to the valve 22 being in an open position. Alternately, when the valve 22 is closed, the pressure values at the two locations 28, 38 can vary from one another. Thus, an operator could attribute different pressures at the two locations 28, 38 to the valve 22 being closed.

Depending upon the application within which the pressure monitoring arrangement 10 is employed, additional information or confidence in the position of the valve 22 can be determined. For example, in applications, such as for that of the instant embodiment wherein the pressure monitoring arrangement 10 is employed within the borehole 42 of the earth formation 46, known conditions of pressures within the borehole 42 can be employed to increase confidence in the determination of the position of the valve 22. An operator can estimate or calculate the hydrostatic pressure within the borehole 42 corresponding to the depth at which the valve 22 is located. If, for example, pressure at the first location 28 corresponds to the estimated/calculated hydrostatic pressure and pressure at the second location 38 is greater than that at the first location 28, the operator can attribute these conditions to the valve 22 being in the closed position with significant confidence. Additionally, unstable values of pressure at the first location 28 as determined by the first pressure transducer 24 can be attributed to leakage by the valve 22 since such leakage could cause momentary increases in pressure at the first location 28 whenever higher pressure from the second location 38 leaks by the valve 22.

Accuracy of the pressure readings from the pressure transducers 24, 34 can also affect confidence with which an operator determines positions of the valve 22. Since accuracy of the pressure transducers 24, 34 can vary with temperature a first temperature gauge 54 is mounted near the first pressure transducer 24 and a second temperature gauge 58 is mounted near the second pressure transducer 34. With the temperatures measured by the temperature gauges 54, 58 the outputs of the pressure transducers 24, 34 can be compensated for based on actual temperatures and effects of such temperatures on the pressure transducers 24, 34. Although each of the pressure transducers 24, 34 illustrated in this embodiment have a temperature gauge 54, 58 positioned nearby, a single temperature gauge may sufficiently monitor the temperature in the area of both of the pressure transducers 24, 34 to allow a single temperature gauge to be employed instead of two as shown herein.

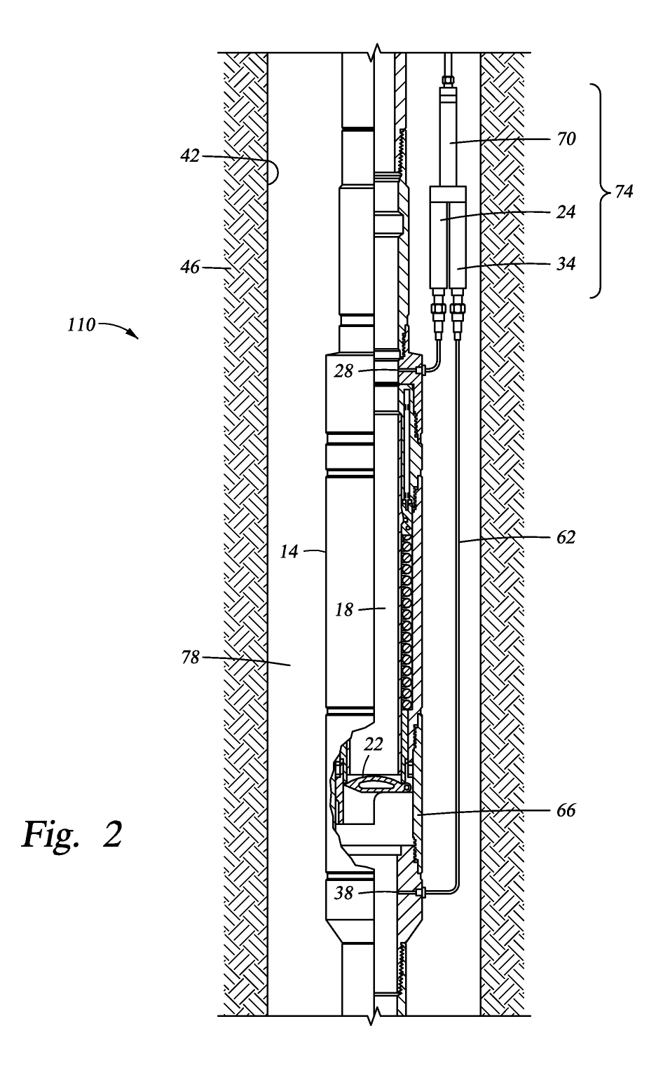

Referring to FIG. 2, an alternate embodiment of a pressure monitoring arrangement employed to practice the methods disclosed herein is illustrated generally at 110. The arrangement 110 is similar to that of the arrangement 10 with the primary difference being that the pressure transducers 24, 34 in the arrangement 110 are collocated on a same longitudinal side of the valve 22. The fact that the transducers 24, 34 are collocated does not alter the fact that they still measure pressure at the first location 28 and the second location 38. A fluidic passageway 62, shown herein as a tubular, provides fluidic communication between the second location 38 and the second pressure transducer 34. Although this fluidic passageway 62 is illustrated herein as a separate tubular it should be noted that porting the fluidic passageway 62 by other means, such as through a wall 66 of the tubular 14 is also contemplated. Routing the passageway 62 in this manner may protect the passageway 62 from damage during running of the tubular 14, for example. Additionally, one or both of the pressure transducers 24, 34 could be welded to the housing 14 directly to reduce the chances of leaks between the bore 18 and an annulus 78 defined between the tubular 14 and the borehole 42.

Additionally, collocating the pressure transducers 24, 34 may facilitate usage of a single temperature gauge 70, since temperature in the proximity of both of the pressure transducers 24, 34 would be substantially similar.

Alternately, the collocated pressure transducers 24, 34 could be replaced with a single differential pressure transducer 74. The differential transducer 74 could be configured to measure the difference in pressure between the first location 28 and the second location 38. A sign (positive or negative) of the output of the differential transducer 74 could be indicative of which location 28, 38 is exhibiting a greater pressure. An advantage of using the single differential pressure transducer 74 over the two separate transducers 24, 34 is that it could automatically compensate for variations in absolute pressure encountered in the locations 28, 38. In a manner similar to that of the arrangement 10 the arrangement 110 can be used to determine various positions of the valve 22. For example, values of differential pressure that are substantially negligible could be attributed to the valve 22 being open, while greater values of differential pressure could be attributed to the valve 22 being in a closed position. Additionally, values of pressure differential, such as having a negative value, for example, indicative of a greater pressure below the valve 22 than above can increase confidence that the valve 22 is indeed closed, while unstable values of differential pressure can be attributed to leakage by the valve 22.

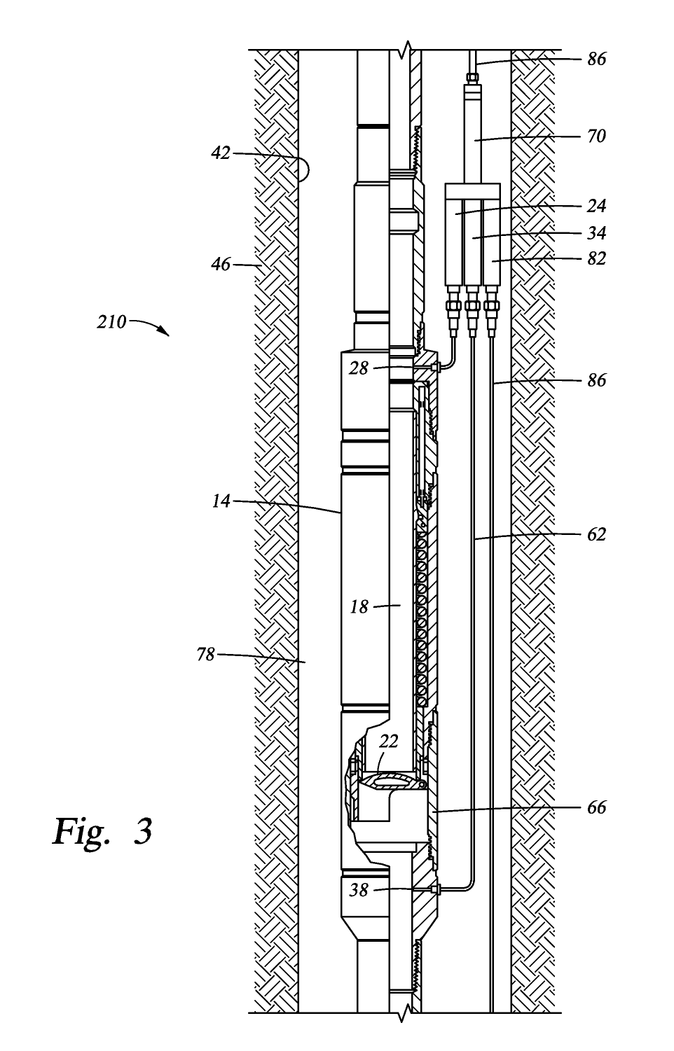

Referring to FIG. 3, an alternate embodiment of a pressure monitoring arrangement employed to practice the methods disclosed herein is illustrated generally at 210. The arrangement 210 is similar to that of the arrangement 110 with the primary differences being that a third pressure transducer 82 is collocated with the pressure transducers 24, 34, and a control line 86, illustrated herein as a tubing encapsulated conductor, is a feed through control line. The third pressure transducer 82 can be configured to monitor pressure in the annulus 78 or in the control line 86 to provide further analysis and troubleshooting capabilities. The feed through nature of the control line 86 will permit the use of multiple devices on the same control line 86.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed:

1. A method of determining position of a valve, comprising:
measuring pressure at a first location within a bore;
measuring pressure at a second location within the bore, the first location and the second location being positioned on opposing longitudinal sides of the valve;
analyzing values from the measuring; and
attributing characteristics of the analyzing to specific valve positions.

2. The method of determining position of a valve of claim 1, further comprising attributing lack of difference between pressures measured at the first location and the second location to the valve being in an open position.

3. The method of determining position of a valve of claim 1, further comprising attributing differences between pressures measured at the first location and the second location to the valve being in a closed position.

4. The method of determining position of a valve of claim 1, further comprising attributing pressure measured at the first location correlating to an anticipated hydrostatic pressure and pressure measured at the second location being greater than the anticipated hydrostatic pressure to the valve being in a closed position for applications wherein the valve is positioned within a borehole in an earth formation and the second location being positioned longitudinally downhole of the valve.

5. The method of determining position of a valve of claim 1, further comprising measuring pressures at the first location with a first pressure transducer and measuring pressures at the second location with a second pressure transducer.

6. The method of determining position of a valve of claim 5, further comprising collocating the first pressure transducer with the second pressure transducer and fluidically porting pressure from at least one of the first location to the first pressure transducer and the second location to the second pressure transducer via a fluidic passageway.

7. The method of determining position of a valve of claim 6, wherein the collocating the first pressure transducer with the second pressure transducer is longitudinally uphole of the valve.

8. The method of determining position of a valve of claim 5, wherein the first pressure transducer is located at the first location and the second pressure transducer is located at the second location.

9. The method of determining position of a valve of claim 1, wherein the valve is a flapper valve.

10. The method of determining position of a valve of claim 1, further comprising measuring temperature at least one of the first location and the second location and compensating the measuring of pressures based upon the temperature measuring.

11. The method of determining position of a valve of claim 1, further comprising attributing unstable pressure measuring to leakage past the valve.

12. A method of determining positions of a valve, comprising:
measuring differences in pressure between locations on opposing longitudinal sides of a valve in operable communication with a bore; and
attributing values of differential pressure measured to positions of the valve.

13. The method of determining positions of a valve of claim 12, further comprising attributing substantially insignificant values of differential pressure to the valve being in an open position.

14. The method of determining positions of a valve of claim 12, further comprising attributing large values of differential pressure to the valve being in a closed position.

15. The method of determining positions of a valve of claim 12, further comprising attributing a value of differential pressure indicating that a downhole pressure is greater than an uphole pressure of the valve to a greater confidence in the valve being in a closed position.

16. The method of determining positions of a valve of claim 12, further comprising attributing unstable values of differential pressure to leakage past the valve.

17. The method of determining positions of a valve of claim 12, further comprising automatically compensating for variations in absolute pressure.

18. The method of determining positions of a valve of claim 12, further comprising compensating values of differential pressure measured based on temperatures of devices employed in the measuring of differences in pressure.
